(19) United States
(12) Patent Application Publication
(10) Pub. No.: US 2022/0162456 A1
(43) Pub. Date: May 26, 2022

(54) Coating Composition Providing An Anodized Appearance

(71) Applicant: PPG Industries Ohio, Inc., Cleveland, OH (US)

(72) Inventors: Ben A. MacFadden, West Olive, MI (US); Kevin M. Larkin, Grand Haven, MI (US)

(73) Assignee: PPG Industries Ohio, Inc., Cleveland, OH (US)

(21) Appl. No.: 17/430,823

(22) PCT Filed: Feb. 14, 2020
(86) PCT No.: PCT/IB2020/051232

§ 371 Date: Aug. 13, 2021

Related U.S. Application Data
(60) Provisional application No. 62/805,716, filed on Feb. 14, 2019.

(51) Int. Cl. C09D 5/03; C09D 163/00; C09C 1/64; C09C 3/10

(52) U.S. Cl. CPC C09D 5/035; C09D 5/032; C01P 2004/02; C09C 1/644; C09C 3/10; C09D 163/00

(57) ABSTRACT

A coating composition includes first composite particles including an effect pigment adhered to polymeric powder and second particles distinct from the first composite particles and not adhered to the first composite particles. The second particles include a colorant including a pigment. A method for imparting an anodized appearance to a substrate and a kit for applying a coating composition to a substrate to impart an anodized appearance to the substrate are also disclosed.

### FIELD OF THE INVENTION

The present invention relates to a coating composition having first composite particles and distinct second particles, a coated substrate, a method for imparting an anodized appearance to a substrate, and a kit for applying a coating composition to a substrate to impart an anodized appearance to the substrate.

### BACKGROUND OF THE INVENTION

Aesthetically, consumers are interested in interior and exterior building products, office furniture, appliances, and other consumer goods that have a finish mimicking the appearance of anodized aluminum. However, acceptably duplicating the appearance of anodized aluminum using a coating composition is difficult.

### SUMMARY OF THE INVENTION

The present invention is directed to a coating composition including: first composite particles including an effect pigment adhered to polymeric powder; and second particles distinct from the first composite particles and not adhered to the first composite particles, the second particles including a colorant including a pigment.

The present invention also is directed to a method for imparting an anodized appearance to a substrate including: heating a first composition including an effect pigment and polymeric powder to a temperature above a softening point of the polymeric powder to form a softened polymeric powder such that the effect pigment adheres to the softened polymeric powder to form first composite particles; cooling the first composite particles to a temperature below the softening point of the polymeric powder; mixing the cooled first composite particles with a colorant including a pigment to form a coating composition such that the colorant is not adhered to the first composite particles; and applying the coating composition to a substrate.

The present invention also is directed to a kit for applying a coating composition to a substrate to impart an anodized appearance to the substrate including: a first container including first composite particles including an effect pigment adhered to polymeric powder; and a separate second container including a colorant, the colorant including a pigment.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an image taken using a standard microscope having 100× magnification of a coated substrate prepared according to Example 8;

FIG. 2 shows an image taken using a standard microscope having 100× magnification of a coated substrate prepared according to Example 9;

FIG. 3 shows an image taken using a standard microscope having 100× magnification of a coated substrate prepared according to Example 10;

FIG. 4 shows a photograph of the coated substrates prepared in Examples 8-10; and

FIG. 5 shows an image taken using a standard microscope having 100× magnification of a coated substrate prepared according to Example 11.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses the singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “an” organic pigment, “a” polymeric powder, and the like refer to one or more of these items. Also, as used herein, the term “polymer” refers to prepolymers, oligomers, and both homopolymers and copolymers. The term “resin” is used interchangeably with “polymer.”

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the invention.

The present invention is directed to a coating composition including: first composite particles comprising an effect pigment adhered to polymeric powder and second particles distinct from the first composite particles and not adhered to the first composite particles. The second particles include a colorant including a pigment.

As used herein, the term “effect pigment” refers to a pigment exhibiting an optical effect resulting from the directional reflection of light from flake-shaped, pelletized, or other shaped particles that are metallic or that have a refractive index contrast. Examples of such effect pigments include metallic effect pigments (e.g., aluminum, stainless steel, zinc, copper or alloys thereof) or interference pigments (e.g., based on titanium dioxide-coated mica such as muscovite, phlogopite and biotite). The effect pigment of the first composite particles may include a metallic flake or pellet or mica. The metallic flake or pellet may include, but is not limited to particles comprising aluminum, gold, silver, nickel, zinc, platinum, bronze, copper, brass, titanium, tungsten, stainless steel, including oxides and alloys thereof. A surface active agent may be deposited thereon, such as a saturated or unsaturated fatty acid, including, without limitation, oleic acid; stearic acid; and/or a derivative thereof; aliphatic amine; aliphatic amide; aliphatic alcohol; ester compound; and the like. These agents are effective in suppressing unnecessary oxidization of the surface of the metallic flake, such as aluminum flake.

The effect pigment may have a median particle size in the range of 2-75 μm, such as from 2-50 μm, 2-40 μm, 2-30 μm, 2-25 μm, 2-10 μm, 5-75 μm 5-50 μm, 5-40 μm, 5-30 μm, 5-25 μm, or 5-10 μm. Median particle size is measured or reported herein according to ISO 13320-1. The effect pigment may comprise 0.1-10 weight percent, such as 1-10 weight percent, 1-7 weight percent, or 1-5 weight percent, of the composition of the first composite particle, based on the weight of the effect pigment and polymeric powder. The effect pigment may have a median particle size of at least 5 μm, such as at least 10 μm, at least 15 μm, at least 20 μm, at least 35 μm, at least 45 μm, or at least 50 μm. The effect pigment may have a median particle size of up to 75 μm, such as up to 70 μm, up to 60 μm, up to 50 μm, up to 40 μm, up to 30 μm, or up to 20 μm.

The polymeric powder of the first composite particle may comprise any polymer that is capable of forming a film. Suitable polymers for the polymeric powder include, but are not limited to, acrylics, polyesters, polyethers, epoxies, fluoropolymers, polyurethanes, and hybrids and/or combinations thereof.

The polymeric powder may have a median particle size in the range of 20-100 μm, such as 35-80 μm, 35-75 μm, 35-60 μm, 30-50 μm, 35-50 μm, 35-45 μm, 20-80 μm, 20-75 μm, 20-60 μm, or 20-50 μm, as measured according to ISO 8130-1. The polymeric powder may comprise 90-99.9 weight percent, such as 90-99 weight percent, 90-93 weight percent, or 90-95 weight percent, of the composition of the first composite particle, based on the weight of the effect pigment and polymeric powder. The polymeric powder may have a median particle size of at least 30 μm, such as at least 35 μm, at least 40, or at least 45 μm. The effect pigment may have a median particle size of up to 50 μm, such as up to 45 μm, up to 40 μm, or up to 35 μm.

The first composite particles include the effect pigment adhered to the polymeric powder. The term “adhered” when used herein with reference to the relationship between the effect pigment and the polymeric powder, means that the effect pigment is attached to, e.g., physically bonded to and/or encapsulated by, the polymeric powder such that upon formation of the first composite particle and its subsequent application to a substrate, such as by electrostatic spraying, the effect pigment does not detach from the polymeric powder.

The effect pigment may be adhered to the polymeric powder to form the first composite particle using a bonding process. The bonding process may include heating (globally and/or locally) a mixture of the polymeric powder and the effect pigment to a softening point of the polymeric powder to form a softened polymeric powder. The effect pigment may be brought into contact with the softened polymeric powder (e.g., by mixing), such that the effect pigment adheres to the softened polymeric powder. The bonding process may heat the polymeric particles to a temperature ranging from 100-155° F. (38-68° C.) for 3-20 minutes. The bonding process may include microwave bonding to adhere the effect pigment to the polymeric powder. The bonding process may include extruding a mixture containing both the polymeric powder and the effect pigment so as to adhere the effect pigment to the polymeric powder.

The effect pigment may be adhered to the polymeric powder with or without the use of an adhesive material intended to promote adhesion of the effect pigment to the polymeric powder.

Optionally, the cooled first composite particles may be separated, such as by sieving, prior to addition of the second particles thereto to remove agglomerates and/or first composite particles outside of a predetermined particle size range. The first composite particles may be separated so that only first composite particles having a particle size in the range of 25-60 μm, such as 30-50 μm or 30-40 μm, remain. The first composite particles may be separated so that only first composite particles having a particle size of up to 60 μm, such as up to 55 μm, up to 50 μm, up to 45 μm, or up to 40 μm, remain.

The second particles may be added to the first composite particles and mixed therewith to form the coating composition. The second particles may be distinct from the first composite particles, such that substantially all (such as at least 90%) of the second particles are not adhered to the polymeric powder, the effect pigment, and the first composite particles. All of the second particles may not be adhered to the polymeric powder, the effect pigment, and the first composite particles.

The second particles may be kept distinct from the first composite particles by first cooling the first composite particles below the softening point of the polymeric powder prior to adding the second particles to the coating composition, such that the second particles do not adhere to softened polymeric powder.

The second particles may include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coating composition. Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coating composition by use of a grind vehicle, such as an acrylic grind vehicle, the use of which will be familiar to one skilled in the art.

The colorant may include an organic pigment, an inorganic pigment, or some combination thereof. Example pigments include, but are not limited to, carbazole dioxazine crude pigment, azo, monoazo, disazo, naphthol AS, salt type (lakes), benzimidazolone, condensation, metal complex (e.g. iron oxide pigments), isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), metal oxide, e.g., iron oxide, titanium dioxide, etc., carbon black, and mixtures thereof.

The colorant may comprise from 0.01-10 weight percent, such as from 0.5-10 weight percent, 1-10 weight percent, 0.01-5 weight percent, 0.5-5 weight percent, or 1-5 weight percent, of the coating composition, based on the total weight of the coating composition. The colorant may comprise at least 0.01 weight percent, such as at least 0.1 weight percent, at least 0.5 weight percent, at least 1 weight percent, at least 2 weight percent, at least 3 weight percent, or at least 4 weight percent, of the coating composition based on the total weight of the coating composition. The colorant may comprise up to 5 weight percent, such as up to 4 weight percent, up to 3 weight percent, up to 2 weight percent, or up to 1 weight percent, of the coating composition based on the total weight of the coating composition.

Optionally, the second particles may be separated, such as by sieving, prior to application of the coating composition to a substrate to remove agglomerates and/or particles outside of a predetermined particle size range. The coating composition may be separated so that only particles having a particle size in the range of 25-60 μm, such as 30-50 μm or 30-40 μm, remain. The coating composition may be separated so that only particles having a particle size of up to 60 μm, such as up to 55 μm, up to 50 μm, up to 45 μm, or up to 40 μm, remain.

The coating composition may be prepared for application to a substrate using a kit for applying a coating composition to the substrate to impart an anodized appearance to the substrate. The kit may include a first container including the first composite particles. The kit may also include a separate second container (different from the first container) containing a colorant. The kit may include a plurality of second containers, each second container including a different pigment to impart the desired color to the coating composition. Each second container may impart a different color to the coating composition compared to the other second containers in the kit.

The coating composition may be applied using the kit by mixing the contents of the first container (the first composite particles) with the contents of the second container(s) (the colorant(s)). The resulting coating composition may be applied to a substrate. The kit may further include instructions for preparing the coating compositions, such as instructions regarding relative amounts of the first composite particles and the colorants to combine to produce a coating composition having a certain color and/or finish.

Once prepared, the coating composition may be applied to a substrate. The coating composition may be applied to a substrate by spraying, such as by electrostatic spraying, use of a fluidized bed, brushing, dipping, flowing, or other suitable application method.

The substrate may comprise metal. The metallic substrate may include aluminum, such as chrome treated aluminum. The metallic substrate may include tin, steel (including stainless steel, electrogalvanized steel, cold rolled steel, and hot-dipped galvanized steel, among others), aluminum alloys, zinc-aluminum alloys, steel coated with a zinc-aluminum alloy, or aluminum plated steel. The metallic substrate may further include a metal pretreatment composition, also referred to as a conversion composition. Examples of suitable pretreatment compositions include, but are not limited to, compositions that contain zinc phosphate, iron phosphate, or chromium-containing components. Other examples of suitable pretreatment compositions include, but are not limited to, thin-film pretreatment compositions, which include compositions such as a zirconium or titanium-containing components. The metal pretreatment composition may also include a sealer, such as a chromate or non-chromate sealer. The metallic substrates may also be coated with a primer such as a cationic electro-coat primer.

The substrate may be non-metallic. Non-metallic substrates may include polymeric materials. Suitable polymeric materials for the substrate may include plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (PET), polycarbonate, polycarbonate acrylonitrile butadiene styrene (PC/ABS), or polyamide. Other non-metallic substrates may include glass, wood, wood veneer, wood composite, particle board, medium density fiberboard, cement, stone, paper, cardboard, textiles, leather, both synthetic and natural, and the like. Non-metallic substrates may also include a treatment coating that is applied before application of the coating, which increases the adhesion of the coating composition to the substrate.

The substrate may include furniture, such as office furniture (e.g., office chairs, desks, filing cabinets, and the like). The substrate may include appliances, such as refrigerators, ovens and ranges, dishwashers, microwaves, washing machines, dryers, small appliances (e.g., coffee makers, slow cookers, pressure cookers, blenders, etc.), and the like. The substrate may include metallic hardware. The substrate may include extruded metal, such as extruded aluminum used in window framing. The substrate may include other indoor and outdoor metallic building materials.

The coating composition can be used alone, or in combination with one or more other coating compositions, such as in a coating system having two or more layers. The coating composition may be applied beneath a clearcoat to form a multilayer coating system. The coating composition may be applied over a basecoat to form a multilayer coating system. The coating composition may be applied as a topcoat of a multilayer coating system.

The coated substrate may have an appearance that mimics the appearance of uncoated anodized aluminum. An “anodized appearance” means that the substrate has the cosmetic effect of reflecting light differently at different angles of observation to give the coating a different appearance at the various angles of observation.

The present invention further includes the subject matter of the following clauses:

Clause 1: A coating composition, comprising: first composite particles comprising an effect pigment adhered to polymeric powder; and second particles distinct from the first composite particles and not adhered to the first composite particles, the second particles comprising a colorant comprising a pigment.

Clause 2: The coating composition of clause 1, wherein none of the colorant is adhered to polymeric powder in the coating composition.

Clause 3: The coating composition of clause 1 or 2, wherein the effect pigment comprises aluminum, mica, stainless steel, or some combination thereof.

Clause 4: The coating composition of any of clauses 1-3, wherein the colorant comprises 0.01-5% by weight of the coating composition.

Clause 5: The coating composition of any of clauses 1-4, wherein the effect pigment is adhered to the polymeric powder using a bonding process.

Clause 6: The coating composition of clause 5, wherein the bonding process comprises heating the polymeric powder to a softening point to form a softened polymeric powder such that the effect pigment adheres to the softened polymeric powder.

Clause 7: The coating composition of clause 5 or 6, wherein the bonding process comprises extruding a mixture containing both the polymeric powder and the effect pigment so as to adhere the effect pigment to the polymeric powder.

Clause 8: The coating composition of any of clauses 1-7, wherein the coating composition comprises a powder coating composition.

Clause 9: A coated substrate having an anodized appearance comprising a substrate coated with the coating composition of any of clauses 1-8.

Clause 10: The coated substrate of clause 9, wherein the substrate comprises a metal.

Clause 11: The coated substrate of clause 9 or 10, wherein the substrate comprises furniture, an appliance, metallic hardware, or extruded metal.

Clause 12: A method for imparting an anodized appearance to a substrate, comprising: heating a first composition comprising an effect pigment and polymeric powder to a temperature above a softening point of the polymeric powder to form a softened polymeric powder such that the effect pigment adheres to the softened polymeric powder to form first composite particles; cooling the first composite particles to a temperature below the softening point of the polymeric powder; mixing the cooled first composite particles with a colorant comprising a pigment to form a coating composition such that the colorant is not adhered to the first composite particles; and applying the coating composition to a substrate.

Clause 13: The method of clause 12, wherein the effect pigment comprises aluminum, mica, stainless steel, or some combination thereof.

Clause 14: The method of clause 12 or 13, wherein heating the first composition comprises extruding the first composition so as to adhere the effect pigment to the polymeric powder.

Clause 15: The method of any of clauses 12-14, wherein the substrate comprises furniture, an appliance, metallic hardware, or extruded metal.

Clause 16: The method of any of clauses 12-15, further comprising separating the cooled first composite particles prior to mixing with the colorant.

Clause 17: The method of any of clauses 12-16, further comprising separating the coating composition prior to applying to the substrate.

Clause 18: A kit for applying a coating composition to a substrate to impart an anodized appearance to the substrate, comprising: a first container comprising first composite particles comprising an effect pigment adhered to polymeric powder; and a separate second container comprising a colorant, the colorant comprising a pigment.

Clause 19: The kit of clause 18, comprising a plurality of second containers, each second container comprising a colorant that imparts a different color compared another second container of the plurality of second containers.

Clause 20: The kit of clause 18 or 19, wherein the effect pigment is adhered to the polymeric powder using a bonding process comprising heating the polymeric powder to a softening point to form a softened polymeric powder such that the effect pigment adheres to the softened polymeric powder.

### EXAMPLES

The following examples are presented to demonstrate the general principles of the invention. The invention should not be considered as limited to the specific examples presented.

### Example 1

### Powder Coating Composition Having Red Organic Pigment

A base powder was produced according to the following formula:

### Base Powder A

TABLE 1

| Component | Weight (grams) |
|---|---|
| URALAC P 5042¹ | 163.1 |
| KUKDO 242G² | 486.9 |
| Matting agent | 37.8 |
| RESIFLOW PL-200³ | 10 |
| Benzoin | 5 |
| Antioxidant | 2.5 |
| Barium Sulfate | 294.7 |

¹Unsaturated polyester resin having an acid value from 50-56 mgKOH/g, available from DSM (Heerlen, Netherlands)
²Epoxy resin having an epoxy equivalent weight from 650-725, available from Kukdo Chemical (Seoul, South Korea)
³Acrylic polymer flow agent, available from Estron Chemical (Calvert City, KY)

The ingredients were mixed together and the mixture was extruded through a 30 mm twin screw extruder (available from Baker Perkins (Peterborough, United Kingdom)). The extruded material was cooled and ground to a particle size having a median particle size value of 30-50 μm to form Base Powder A.

Base Powder A was bonded with 2.0 weight percent STANDART PCS 600 Aluminum Powder (with a median particle size value of 6 μm) (available from Eckart America Corporation (Painesville, Ohio)) through a standard bonding process. In these examples, except where indicated otherwise, the standard bonding process involved mixing the polymer powder until above a softening point of the polymeric powder and introducing the effect pigment into the polymeric powder and mixing until the effect pigment is bonded to the polymeric powder. The bonded aluminum powder was sieved using an 80-140 standard US mesh to remove any oversized particles generated during the bonding process.

The bonded aluminum powder below the softening point of the polymeric powder was blended with 3 weight percent 1229 Quinacridone Magenta 122 (available from Lansco Colors (Pearl River, N.Y.)) in a Henschel MBL 10 liter mixer at 1800 rpm for 30 seconds to form the powder coating composition. The powder coating composition was sieved using an 80-140 standard US mesh to remove any oversized particles generated during blending. The powder coating composition was applied to a steel substrate with an electrostatic powder spray gun. The coated substrate was cured in a gas oven at 350° F. (177° C.) for 20 minutes.

### Example 2

### Powder Coating Composition Having Violet Organic Pigment

A base powder was produced according to the following formula:

### Base Powder B

TABLE 2

| Component | Weight (grams) |
|---|---|
| REAFREE 5700⁴ | 870 |
| 1,3,5-tris(oxiranylmethyl)-1,3,5-triazine- | 65 |
| 2,4,6(1H,3H,5H)-trione | |
| RESIFLOW PL-200³ | 10 |
| Benzoin | 5 |
| 1,4-Cyclohexane Dimethanol Dibenzoate | 50 |

⁴Unsaturated polyester resin having an acid value from 33-38 mgKOH/g, available from Arkema (Colombes, France)

The ingredients were mixed together and the mixture was extruded through a 30 mm twin screw extruder (available from Baker Perkins (Peterborough, United Kingdom)). The extruded material was cooled and ground to a particle size having a median particle size value of 30-50 μm to form Base Powder B.

Base Powder B was bonded with 2.0 weight percent STANDART PCS 5000 Aluminum Powder (with a median particle size value of 50 μm) (available from Eckart America Corporation (Painesville, Ohio)) through the standard powder bonding process. The bonded aluminum powder was sieved using an 80-140 standard US mesh to remove any oversized particles generated during the bonding process.

The bonded aluminum powder below the softening point of the polymeric powder was blended with 4 weight percent Lansco 1233 Carbazole Violet 23 (available from Lansco Colors (Pearl River, N.Y.)) in a Henschel MBL 10 liter mixer at 1800 rpm for 30 seconds to form the powder coating composition. The powder coating composition was sieved using an 80-140 standard US mesh to remove any oversized particles generated during blending. The powder coating composition was applied to a steel substrate with an electrostatic powder spray gun. The coated substrate was cured in a gas oven at 350° F. (177° C.) for 20 minutes.

### Example 3

### Powder Coating Composition Having Multiple Inorganic Pigments

The bonded aluminum powder below the softening point of the polymeric powder produced in Example 1 was blended with 1.5 weight percent Iron Oxide red (BAYFERROX 105M available from LANXESS (Cologne, Germany)) and 1.5 weight percent Iron Oxide yellow (BAYFERROX 3910 available from LANXESS (Cologne, Germany)) in a Henschel MBL 10 liter mixer at 1800 rpm for 30 seconds to form the powder coating composition. The powder coating composition was sieved using an 80-140 standard US mesh to remove any oversized particles generated during blending. The powder coating composition was applied to a steel substrate with an electrostatic powder spray gun. The coated substrate was cured in a gas oven at 350° F. (177° C.) for 20 minutes.

### Example 4

### Powder Coating Composition Having Bonded Stainless Steel Flakes

The Base Powder A from Example 1 was mixed with 4.0 weight percent STAY/STEEL LN 25 (stainless steel flake pigment from Eckart America Corporation (Painesville, Ohio) with a median particle size value of 25 μm) through the standard bonding process. The bonded stainless steel powder was sieved using an 80-140 standard US mesh to remove any oversized particles generated during the bonding process.

The bonded stainless steel powder below the softening point of the polymeric powder was blended with 3 weight percent Iron Oxide Red pigment (BAYFERROX 105M available from LANXESS (Cologne, Germany)) in a Henschel MBL 10 liter mixer at 1800 rpm for 30 seconds to form the powder coating composition. The powder coating composition was sieved using an 80-140 standard US mesh to remove any agglomerates or conglomerates. The powder coating composition was applied to a steel substrate with an electrostatic powder spray gun. The coated substrate was cured in a gas oven at 350° F. (177° C.) for 20 minutes.

### Example 5

### Powder Coating Composition Having Blend of Inorganic and Organic Pigments

The bonded aluminum powder below the softening point of the polymeric powder from Example 1 was blended with 2.6 weight percent Iron Oxide Red pigment (BAYFERROX 105M available from LANXESS (Cologne, Germany)) and 0.4 weight percent 1233 Carbazole Violet 23 (available from Lansco Colors (Pearl River, N.Y.)) in a Henschel MBL 10 liter mixer at 1800 rpm for 30 seconds to form the powder coating composition. The powder coating composition was sieved using an 80-140 standard US mesh to remove any agglomerates or conglomerates. The powder coating composition was applied to a steel substrate with an electrostatic powder spray gun. The coated substrate was cured in a gas oven at 350° F. (177° C.) for 20 minutes.

### Example 6

### Powder Coating Composition Having Multiple Organic Pigments

The bonded aluminum powder below the softening point of the polymeric powder from Example 1 was blended with 1.5 weight percent 8200 Phthalo Blue 15:2 (available from Lansco Colors (Pearl River, N.Y.)) and 1 weight percent 1233 Carbozale Violet 23 (available from Lansco Colors (Pearl River, N.Y.)) in a Henschel MBL 10 liter mixer at 1800 rpm for 30 seconds to form the powder coating composition. The powder coating composition was sieved using an 80-140 standard US mesh to remove any agglomerates or conglomerates. The powder coating composition was applied to a steel substrate with an electrostatic powder spray gun. The coated substrate was cured in a gas oven at 350° F. (177° C.) for 20 minutes.

### Example 7

### Powder Coating Composition Having Violet Organic Pigment

The Base Powder A from Example 1, was mixed with 2.0 weight percent STANDART PCS 900 Aluminum Powder (with a median particle size value of 9 μm) (available from Eckart America Corporation (Painesville, Ohio)) through the standard bonding process. The bonded powder was sieved using an 80-140 standard US mesh to remove any oversized particles generated during the bonding process.

The bonded stainless steel powder below the softening point of the polymeric powder was blended with 3 weight percent 1233 Carbazole Violet 23 (available from Lansco Colors (Pearl River, N.Y.)) in a Henschel MBL 10 liter mixer at 1800 rpm for 30 seconds to form the powder coating composition. The powder coating composition was sieved using an 80-140 standard US mesh to remove any agglomerates or conglomerates. The powder coating composition was applied to a steel substrate with an electrostatic powder spray gun. The coated substrate was cured in a gas oven at 350° F. (177° C.) for 20 minutes.

### Example 8

### Powder Coating Composition Having Violet Organic Pigment

A base powder was produced according to the following formula:

### Base Powder C

TABLE 3

| Component | Weight (grams) |
|---|---|
| URALAC P 5042¹ | 390 |
| KUKDO 242G² | 260 |
| Matting agent | 55 |
| RESIFLOW PL-200³ | 10 |
| Benzoin | 5 |
| Antioxidant | 2.5 |
| Lubricant | 8 |
| Barium Sulfate | 167.5 |

The ingredients were mixed together and the mixture was extruded through a 30 mm twin screw extruder (available from Baker Perkins (Peterborough, United Kingdom)). The extruded material was cooled and ground to a particle size having a median particle size value of 30-50 μm to form Base Powder C.

Base Powder C was bonded with 2.2 weight percent STANDART PCS 600 Aluminum Powder (with a median particle size value of 6 μm) (available from Eckart America Corporation (Painesville, Ohio)) through the standard bonding process. The bonded powder was sieved using an 80-140 standard US mesh to remove any oversized particles generated during the bonding process.

The bonded powder below the softening point of the polymeric powder was blended with 1 weight percent 1233 Carbazole Violet 23 (available from Lansco Colors (Pearl River, N.Y.)) in a Henschel MBL 10 liter mixer at 1800 rpm for 30 seconds to form a powder coating composition. The powder coating composition was sieved using an 80-140 standard US mesh to remove any oversized particles generated during blending. The powder coating composition was applied to a steel substrate with an electrostatic powder spray gun. The coated substrate was cured in a gas oven at 350° F. (177° C.) for 20 minutes.

### Comparative Example 9

### Powder Coating Composition Having Pigment Added to Base Powder in Extruded Formula

A base powder was produced according to the following formula:

### Base Powder D

TABLE 4

| Component | Weight (grams) |
|---|---|
| URALAC P 5042¹ | 390 |
| KUKDO 242G² | 260 |
| Matting agent | 55 |
| RESIFLOW PL-200³ | 10 |
| Benzoin | 5 |
| Antioxidant | 2.5 |
| Lubricant | 8 |
| 1233 Carbazole Violet 23⁵ | 1 |
| Barium Sulfate | 166.5 |

⁵1233 Bluish violet pigment available from Lansco Colors (Pearl River, NY)

Base Powder D was bonded with 2.2 weight percent STANDART PCS 600 Aluminum Powder (with a median particle size value of 6 μm) (available from Eckart America Corporation (Painesville, Ohio)) through the standard bonding process to form a powder coating composition. The powder coating composition was sieved using an 80-140 standard US mesh to remove any oversized particles generated during the bonding process.

Although this powder coating composition contained the same concentration of both STANDART PCS 600 and the carbzole violet pigment, the color and appearance of this powder coating composition was substantially different from the powder coating composition produced in Example 8. Incorporation of the violet carbzole pigment as part of the extruded powder formula yielded a different product than was generated by blending the pigment after the bonding process was complete.

### Comparative Example 10

### Powder Coating Composition Having Pigment Added as Part of Bonding Step

Base Powder C was bonded with 2.2 weight percent STANDART PCS 600 Aluminum Powder (with a median particle size value of 6 μm) (available from Eckart America Corporation (Painesville, Ohio)) and 1 weight percent 1233 Carbazole Violet 23 (Pearl River, N.Y.) through the standard bonding process to form a powder coating composition. The powder coating composition was sieved using an 80-140 standard US mesh to remove any oversized particles generated during the bonding process.

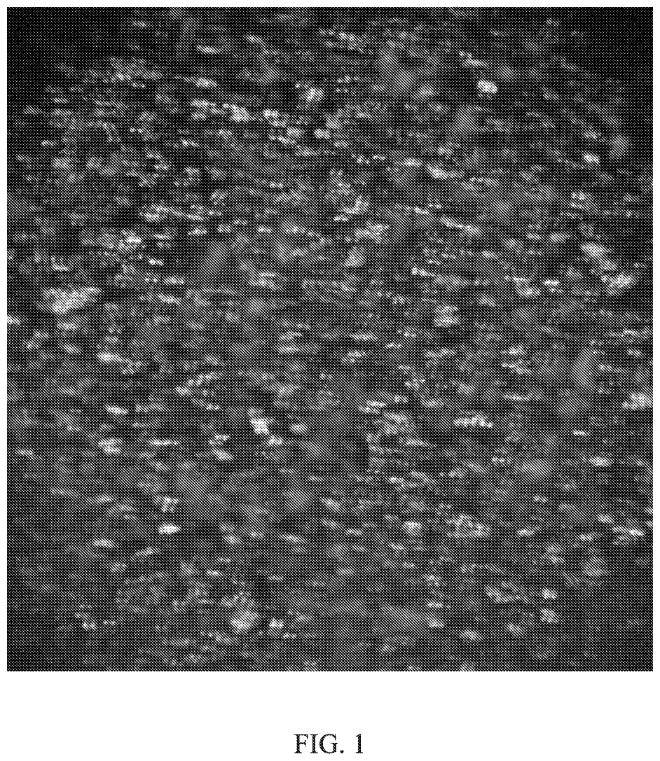

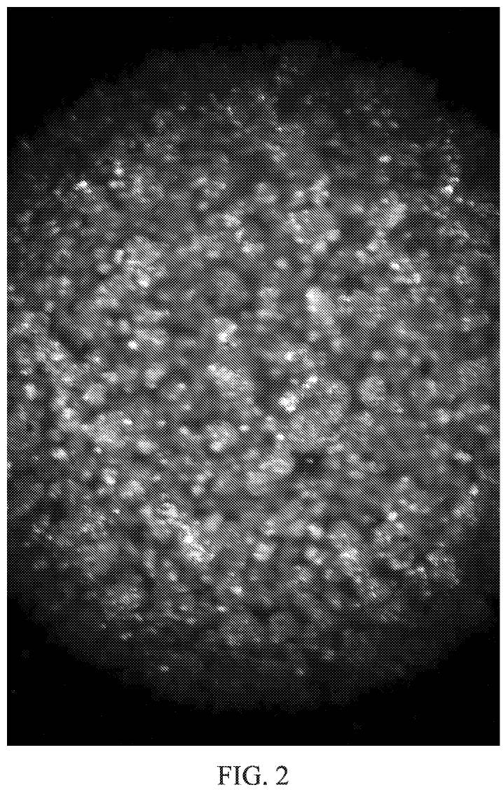

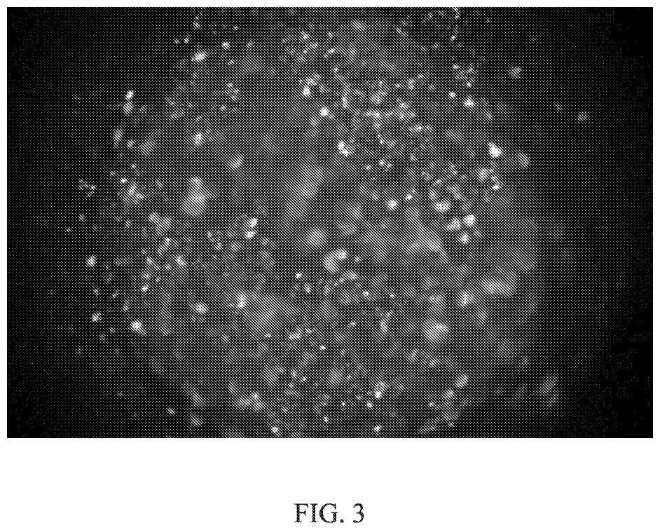

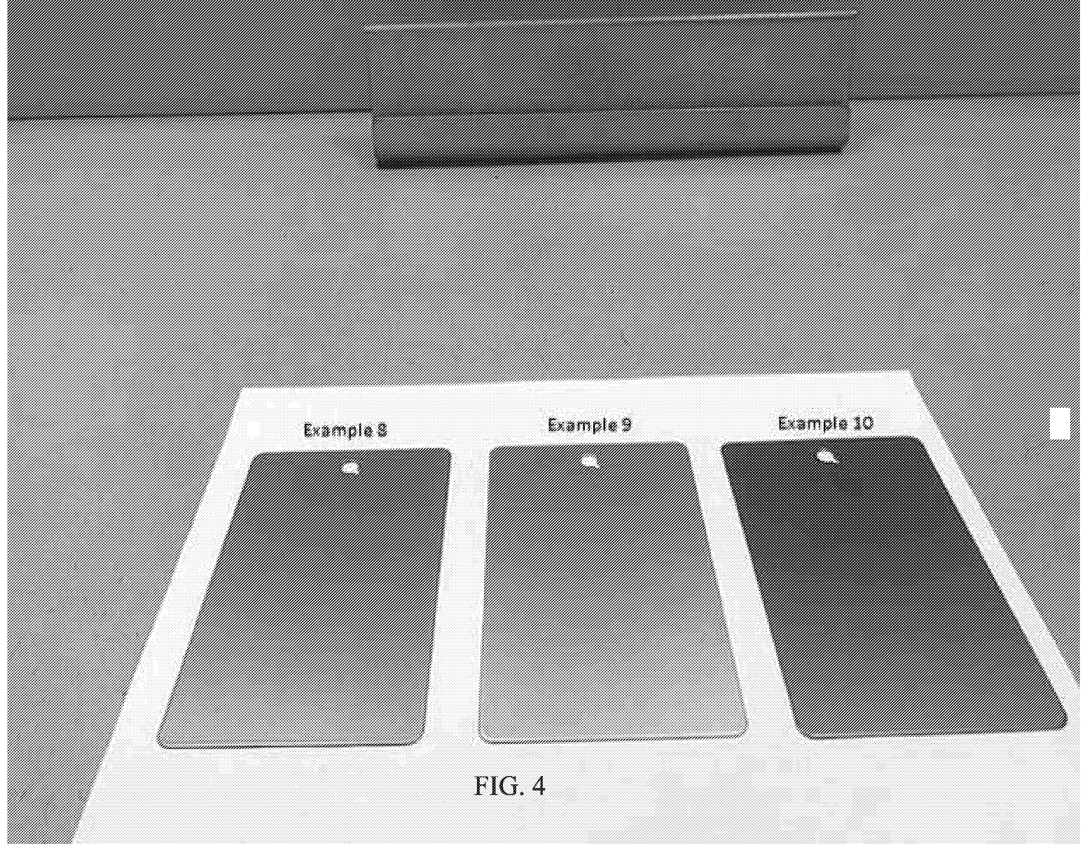

Although this powder coating composition contains the same concentration of both STANDART PCS 600 and the carbzole violet pigment, the color and appearance of this powder coating composition was substantially different from the powder coating composition produced in Example 8. Incorporation of the violet pigment as part of the bonding process yielded a different product than was generated by blending the pigment after the bonding process was complete. FIGS. 1-3 show images taken using a standard microscope having 100× magnification of the coated substrates prepared according to Examples 8-10 having different appearances. FIG. 4 shows a standard photograph of the coated substrates prepared according to Examples 8-10, which have different appearances. Only the panel prepared according to Example 8 resembled an anodized appearance.

### Example 11

### Preparation of a Powder Coating Composition Using Extrudable Aluminum Pellets

A base powder was produced according to the following formula:

### Base Powder E

TABLE 5

| Component | Weight (grams) |
|---|---|
| URALAC P 5042¹ | 190 |
| KUKDO 242G² | 460 |
| Matting agent | 33.3 |
| RESIFLOW PL-200³ | 10 |
| Lubricant | 8 |
| Benzoin | 5 |
| Antioxidant | 2.5 |
| Barium Sulfate | 191.2 |
| Pelletized Extrudable Aluminum | 80 |
| (20 micron median particle size flake) | |
| Pelletized Extrudable Aluminum | 20 |
| (45 micron median particle size flake) | |

The ingredients from Table 5 were mixed together, and the mixture was extruded through a 30 mm twin screw extruder (available from Baker Perkins (Peterborough, United Kingdom)). The extruded material was cooled and ground to a median particle size value of 30-50 μm. The polymeric powder and the pelletized extrudable aluminum from the mixture were adhered as a result of the extrusion.

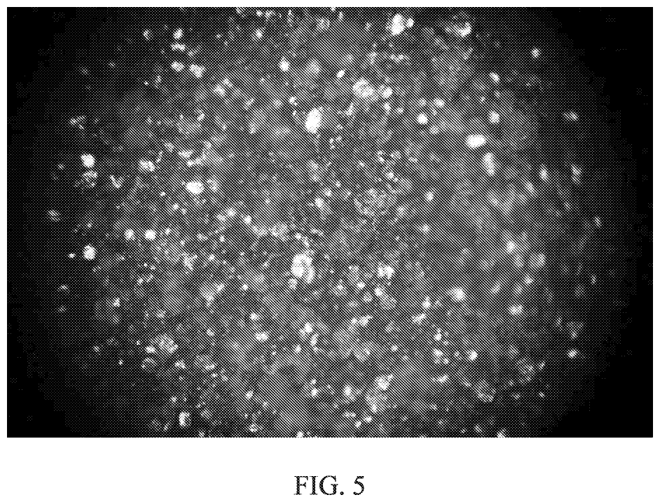

The base powder was blended with 3 weight percent Phthalocyanine Blue pigment (Clariant Hostaperm Blue A4R, pigment Blue 15:2, available from Clariant Specialty Chemicals (Muttenz, Switzerland)) in a Henschel MBL 10 liter mixer at 1800 rpm for 30 seconds. The blended powder was sieved using an 80-140 standard US mesh to remove any oversize particles generated during blending. The final product was applied to a steel substrate with an electrostatic powder spray gun. The coated steel substrate was cured in a gas oven at 350° F. (177° C.) for 20 minutes. FIG. 5 shows an image taken using a standard microscope having 100× magnification of the coated substrates prepared according to Example 11.

Whereas particular embodiments of this invention have been described above for purposes of illustration, it will be evident to those skilled in the art that numerous variations of the details of the present invention may be made without departing from the invention as defined in the appended claims.

The invention claimed is:

1. A coating composition, comprising:
first composite particles comprising an effect pigment adhered to polymeric powder; and
second particles distinct from the first composite particles and not adhered to the first composite particles, the second particles comprising a colorant comprising a pigment.

2. The coating composition of claim 1, wherein none of the colorant is adhered to polymeric powder in the coating composition.

3. The coating composition of claim 1, wherein the effect pigment comprises aluminum, mica, stainless steel, or some combination thereof.

4. The coating composition of claim 1, wherein the colorant comprises 0.01-5% by weight of the coating composition.

5. The coating composition of claim 1, wherein the effect pigment is adhered to the polymeric powder using a bonding process.

6. The coating composition of claim 5, wherein the bonding process comprises heating the polymeric powder to a softening point to form a softened polymeric powder such that the effect pigment adheres to the softened polymeric powder.

7. The coating composition of claim 5, wherein the bonding process comprises extruding a mixture containing both the polymeric powder and the effect pigment so as to adhere the effect pigment to the polymeric powder.

8. The coating composition of claim 1, wherein the coating composition comprises a powder coating composition.

9. A coated substrate having an anodized appearance comprising a substrate coated with the coating composition of claim 1.

10. The coated substrate of claim 9, wherein the substrate comprises a metal.

11. The coated substrate of claim 9, wherein the substrate comprises furniture, an appliance, metallic hardware, or extruded metal.

12. A method for imparting an anodized appearance to a substrate, comprising:
heating a first composition comprising an effect pigment and polymeric powder to a temperature above a softening point of the polymeric powder to form a softened polymeric powder such that the effect pigment adheres to the softened polymeric powder to form first composite particles;
cooling the first composite particles to a temperature below the softening point of the polymeric powder;
mixing the cooled first composite particles with a colorant comprising a pigment to form a coating composition such that the colorant is not adhered to the first composite particles; and
applying the coating composition to a substrate.

13. The method of claim 12, wherein the effect pigment comprises aluminum, mica, stainless steel, or some combination thereof.

14. The method of claim 12, wherein heating the first composition comprises extruding the first composition so as to adhere the effect pigment to the polymeric powder.

15. The method of claim 12, wherein the substrate comprises furniture, an appliance, metallic hardware, or extruded metal.

16. The method of claim 12, further comprising separating the cooled first composite particles prior to mixing with the colorant.

17. The method of claim 12, further comprising separating the coating composition prior to applying to the substrate.

18. A kit for applying a coating composition to a substrate to impart an anodized appearance to the substrate, comprising:
a first container comprising first composite particles comprising an effect pigment adhered to polymeric powder; and
a separate second container comprising a colorant, the colorant comprising a pigment.

19. The kit of claim 18, comprising a plurality of second containers, each second container comprising a colorant that imparts a different color compared another second container of the plurality of second containers.

20. The kit of claim 18, wherein the effect pigment is adhered to the polymeric powder using a bonding process comprising heating the polymeric powder to a softening point to form a softened polymeric powder such that the effect pigment adheres to the softened polymeric powder.
